(19) United States
(12) Patent Application Publication
(10) Pub. No.: US 2025/0332556 A1
(43) Pub. Date: Oct. 30, 2025

(54) CONTAINER FOR MANUALLY MIXING CONTENTS THEREIN

(71) Applicant: Anchor Packaging, LLC, St. Louis, MO (US)

(72) Inventors: Michael A. Pohlman, Valley Park, MO (US); Michael B. Tyberghein, Roswell, GA (US)

(21) Appl. No.: 18/649,731

(22) Filed: Apr. 29, 2024

(51) Int. Cl. B01F 29/30; B01F 29/00; B01F 33/501

(52) U.S. Cl. CPC B01F 29/30; B01F 29/40111; B01F 33/50111

(57) ABSTRACT

A container for manually mixing contents therein includes a base and a lid, and when formed has a first horizontal axis, a second horizontal axis, and a vertical axis that is perpendicular to the horizontal axes. The base defines an elliptic-shaped base opening and a base chamber having two conjugate diameters D₁ and D₂ proximate the base opening. The lid defines an elliptic-shaped lid opening and a lid chamber having the two conjugate diameters D₁ and D₂ proximate the lid opening. The diameter D₁ extends in a direction of the first horizontal axis and the diameter D₂ extends in a direction of the second horizontal axis. A ratio of D₁ to D₂ is greater than 1. The container also includes grips for manually mixing the contents within the base and lid chambers by rotating the container about the second horizontal axis.

### BACKGROUND

The field of the disclosure relates generally to mixing containers and, more particularly, to containers that are used to manually mix contents therein.

Containers are frequently used to store and/or transport components and to mix the components therein. In food applications, containers may be used by a user to mix different food items prior to consumption, and the mixed food items can then be stored and/or transported in the same container without having to transfer the food items to another receptacle. For example, a salad and dressing mixture or a sauce and chicken wings mixture may be manually mixed within a container by a user to obtain a desired heterogenous distribution of the ingredients prior to consumption and then consumed from the container, transported to another location, or stored for later use.

Some known food storage containers are specifically designed for mixing food items therein. Oftentimes, the design attempts to increase an interior volume of the container to provide more room for the contents to move during mixing. However, this typically results in an oversizing and larger footprint of the container, which is undesired for the storage and transportation functionality and for inventory storage of the container prior to use. Larger size containers also have greater material and/or manufacturing costs.

There is an ongoing need for improvements in the manufacturability and/or design of such containers that reduce the footprint of the container while still allowing for suitable mixing therein, reduce costs, improve the durability of the container, and/or improve the usability of the container.

### BRIEF DESCRIPTION

In one aspect, a container for manually mixing contents therein is provided. The container when formed having a first longitudinally horizontal axis A₁, a second laterally horizontal axis A₂, and a vertical axis A₃ that is perpendicular to the horizontal axes A₁ and A₂. The container includes a base and a lid. The base includes a bottom, a base rim, and a base sidewall extending between the bottom and the base rim in a direction of the vertical axis A₃ and defining a base chamber. The base rim defines an elliptic-shaped base opening, and the base chamber has two conjugate diameters D₁ and D₂ proximate the base opening and two conjugate diameters D₃ and D₄ proximate the bottom. The lid includes a top, a lid rim, and a lid sidewall extending between the lid rim and the top in the direction of the vertical axis A₃ and defining a lid chamber. The lid rim engages the base rim when the container is formed and defines an elliptic-shaped lid opening. The lid chamber has the two conjugate diameters D₁ and D₂ proximate the lid opening and two conjugate diameters D₅ and D₆ proximate the top. The diameters D₁, D₃, and D₅ extend in a direction of the longitudinally horizontal axis A₁ and the diameters D₂, D₄, and D₆ extend in a direction of the laterally horizontal axis A₂. A ratio of D₁ to D₂ is greater than 1, a ratio of D₃ to D₄ is greater than 1, and a ratio of D₅ to D₆ is greater than 1. The container also includes grips extending outwardly from the container when formed, each grip sized, shaped, and positioned to be grasped by a hand of a user for manually mixing the contents within the base and lid chambers by rotating the container about the laterally horizontal axis A₂.

In another aspect, a method of mixing contents using the container of the preceding aspect is provided. The method includes placing the contents within the base chamber; forming the container by engaging the lid rim and the base rim to enclose the contents within the base and lid chambers; and manually mixing the contents by rotating the container about the laterally horizontal axis A₂. During rotation of the container the contents reciprocate between the base and lid chambers and are centered relative to a plane defined by the longitudinally horizontal axis A₁ and the vertical axis A₃ such that the contents are substantially mixed without rotating the container in another direction.

### BRIEF DESCRIPTION OF THE DRAWINGS

FIG. 1 is a perspective view of an example container in a closed configuration.

FIG. 2 is a front elevation view of the container of FIG. 1.

FIG. 3 is side elevation view of the container of FIG. 1.

FIG. 4 is a top plan view of the container of FIG. 1.

FIG. 5 is an isolated perspective view of a base of the container of FIG. 1.

FIG. 6 is an isolated top plan view of the base of FIG. 5.

FIG. 7 is an isolated perspective view of a lid of the container of FIG. 1.

FIG. 8 is an isolated bottom plan view of the lid of FIG. 7.

FIG. 9 is a section view of the container of FIGS. 1-4, taken along section line 9-9 in FIG. 4.

FIG. 10 is a magnified view of region indicated at 10 in FIG. 9.

FIG. 11 is a section view of the container of FIGS. 1-4, taken along section line 11-11 in FIG. 4.

FIG. 12 is a magnified view of region indicated at 12 in FIG. 11.

FIGS. 13 and 14 are magnified views of vent channels included in the base of FIGS. 5 and 6.

FIGS. 15 and 16 are magnified views of vent channels included in the lid of FIGS. 7 and 8.

FIG. 17 is a schematic illustrating a partial vent formed by an aligning pair of a vent channel of the base shown in FIGS. 13 and 14 and a vent channel of the lid shown in FIGS. 15 and 16.

FIGS. 18 and 19 illustrate a sequence of forming the container of FIGS. 1-4 and creating a peripheral seal between the base and lid using a single downward force.

Corresponding reference numerals used throughout the drawings indicate corresponding elements and components.

### DETAILED DESCRIPTION OF THE INVENTION

Embodiments described herein relate to containers for storing and/or transporting contents (e.g., items of food) that can be used to manually mix the contents therein. The containers described herein are suitably used to mix multiple different food ingredients prior to consumption. In some examples the containers are used for applying a sauce or condiment to a food item or items, such as applying sauce to chicken wings or mixing a salad with dressing. The containers are dimensioned to allow sufficient mixing of the contents therein by a user while reducing the amount of effort required to achieve sufficient mixing and also reducing the size and footprint of the container.

In particular, examples of containers described herein have an oblong or substantially frusto-ellipsoid shape and are formed by a lid and base each defining an elliptic opening and a mixing chamber. The mixing chambers of the lid and base cooperate to define the interior volume of the container in which mixing is performed. The elliptic openings of the lid and base have complementing conjugate diameters that are sized to facilitate centering the contents relative to a longitudinal plane while the container is rotated about a laterally horizontal axis. The mixing chambers of the lid and the base also have a height such that, during rotation of the container, the contents reciprocate between the base and lid mixing chambers to achieve sufficient mixing. As a result, a user can avoid excessive effort to achieve sufficient mixing that is typically required when using containers that do not facilitate controlled and directional mixing (e.g., in circular mixing containers). Additionally, the interior volume can be relatively limited in size while still achieving sufficient mixing, thus facilitating reducing size and footprint of the container.

In various examples, the containers also include additional dimensional characteristics and/or features to improve the functionality and/or usability of the container. For example, the mixing chambers of the lid and the base may have tapered diameters defined by curved sidewalls that enhance mixing efficiency (e.g., by limiting deviation from the center of the container during rotation) and promote downward pooling of the mixed contents for consumption. Grips may be provided on the periphery of the container at lateral sides thereof to allow a user to easily and comfortably rotate the container about the mixing axis (i.e., the laterally horizontal axis). The elliptic openings, which are defined in the base and lid by a respective rim, may also allow for an easy and efficient closure mechanism whereby the user can create a continuous peripheral seal in a single motion (i.e., by application of a single downward force to the lid to create the peripheral seal with the base). Structural ribs may be included to allow the sidewalls to resist the downward force and enable the user to create the peripheral seal via the single downward force without the sidewalls collapsing. The structural ribs may also be outwardly-extending and tapered, with a reduced surface area at terminal contact points that allow a user to handle the container while minimizing exposure to heat from contents (e.g., hot food items) stored therein. These advantages and additional advantages will become more apparent to those skilled in the art from the following description of example embodiments.

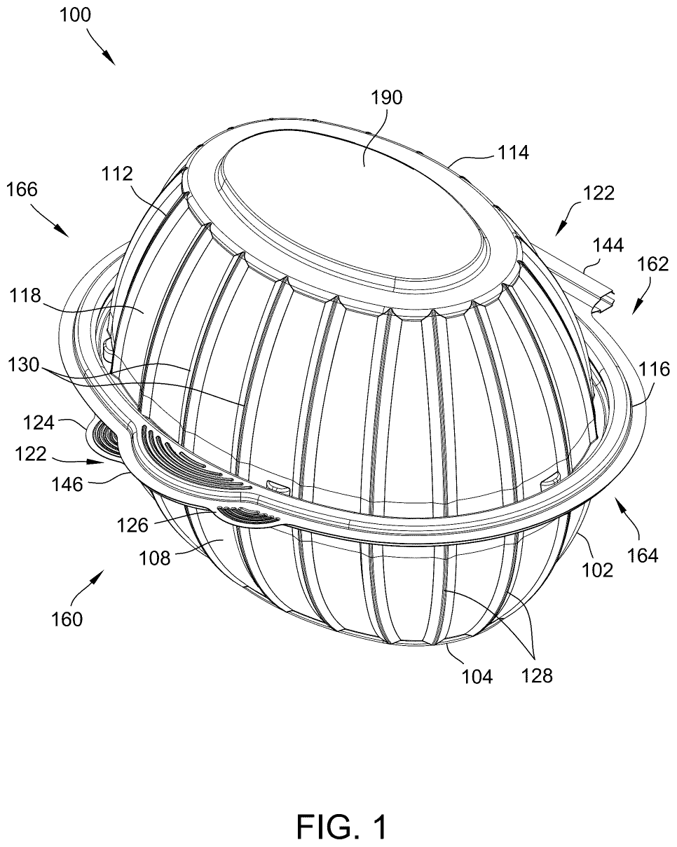

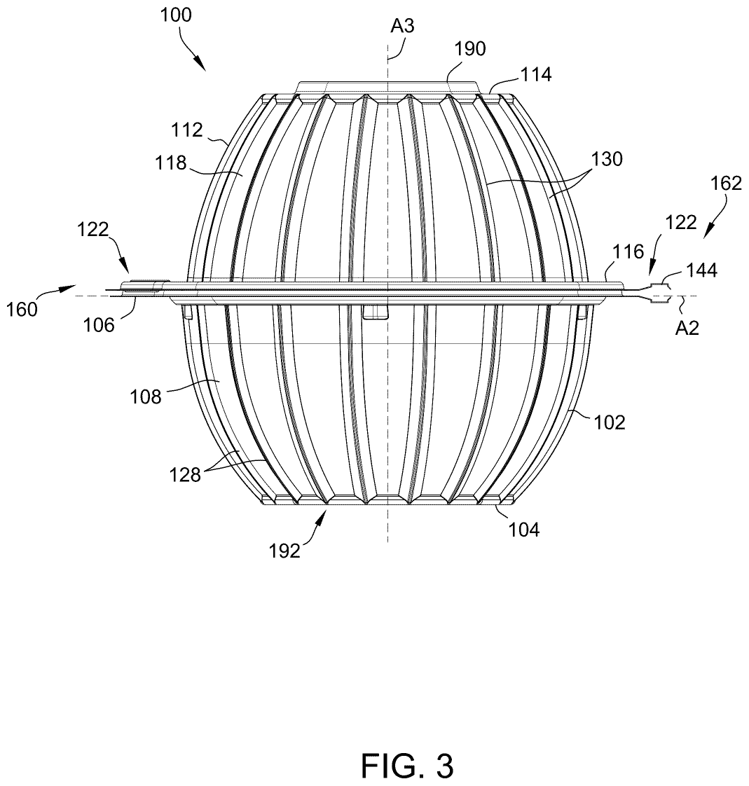

Referring now to the drawings, FIGS. 1-4 depict an example container 100 that is used to transport and/or store contents, such as food items. The container 100 is also used to manually mix the contents therein and, as will be described below, enables sufficient mixing of the contents therein while reducing an effort required by a user of the container 100 and reducing a size and footprint required of the container 100 while doing so. In some applications, the container 100 is used to mix multiple food items or ingredients, such as for applying sauce to chicken wings or mixing salad and dressing. However, it will be appreciated that the container 100 can be used in various mixing applications, and is not limited to mixing food ingredients.

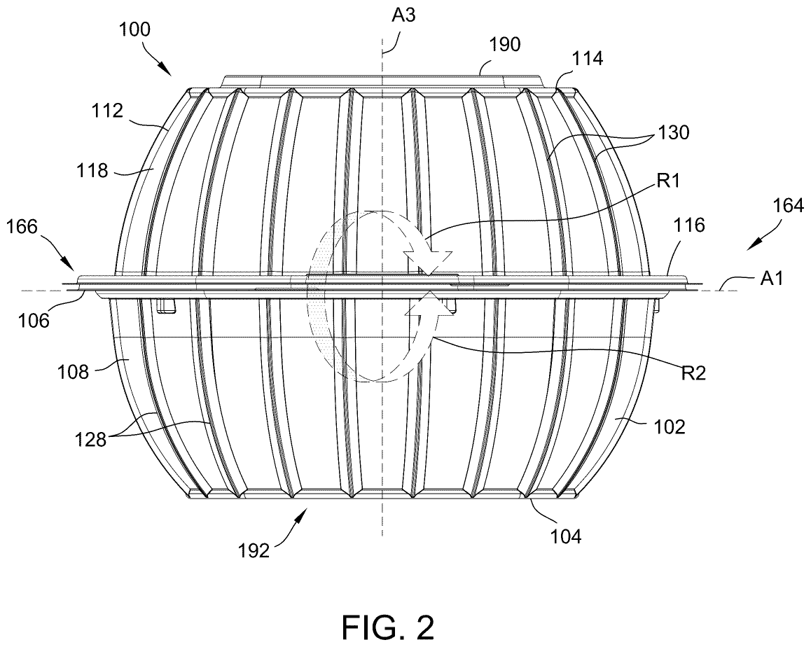

The container 100 includes a base 102 and a lid 112. In the orientation shown in FIGS. 1-4, the base 102 is located vertically below the lid 112. When the container 100 is in use, and in particular when the container 100 is being used to mix contents therein, the container 100 will assume various orientations as it is manipulated by a user. In this regard, elements and components of the container 100 are described relative to the orientation of the container 100 shown in FIGS. 1-4, but the container 100 is not limited to any particular orientation. As shown in FIGS. 2-4, the container 100 when formed has a first axis A₁, a second axis A₂ that is perpendicular to the first axis A₁, and a third axis A₃ that is perpendicular to the axes A₁ and A₂. The first axis A₁ is also referred to herein as a first longitudinally horizontal axis A₁. The second axis A₂ is also referred to herein as a second laterally horizontal axis A₂. The third axis A₃ is also referred to herein as a vertical axis A₃. Directional terms used to describe the axes A₁-A₃ and a spatial relation between any of the components herein, including the base 102 and the lid 112 and elements and components of the base 102 and the lid 112, are used with reference to the orientation of the container 100 and solely for convenience of description. For example, the terms “horizontally,” “vertically,” “outer,” “peripheral,” “outwardly,” “upper,” “inner,” “inwardly,” “upwardly,” “downwardly,” and similar or other directional terms are not limiting with regard to a particular orientation of any component, including the container 100 and the other elements and features described herein.

The lid 112 releasably engages the base 102 to form the container 100, that is, to move the container 100 into a closed configuration, or alternatively stated, to close the container 100 and enclose the contents therein. The lid 112 is releasable from the base 102 to move the container 100 into an open configuration, that is, to open the container 100 by separating the lid 112 from the base 102 and enable access to the contents therein. Engagement between the base 102 and the lid 112 to close the container 100 will be described below. The base 102 and the lid 112 are joined by a hinge 144 that allows the base 102 and the lid 112 to move between the open and closed configurations of the container 100 without becoming fully separated from each other. The hinge 144 also serves as a grip 122 for the user of the container 100 to manipulate the container 100 for mixing the contents therein, described in more detail below. In other examples, the hinge 106 is omitted and the base 102 and the lid 112 fully separate from each other when the container 100 is in the open configuration. In examples where the hinge 144 is omitted, another grip 122 may be used in lieu of the hinge 144, such as a grip 122 that includes one or more tabs 124, 126, 146 as described in more detail below.

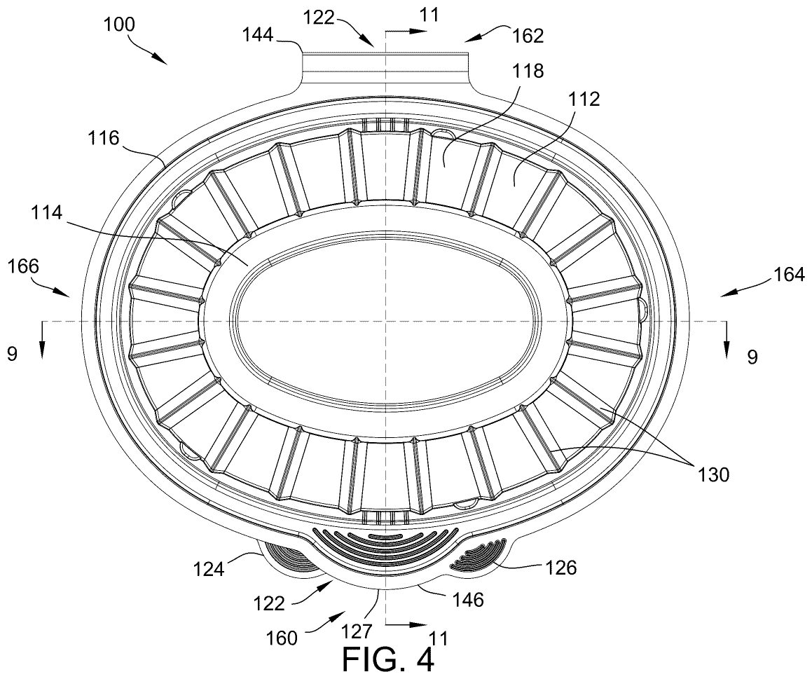

The example container 100 has an oblong shape that facilitates improving or enhancing mixing of the contents therein. As shown in FIGS. 1-4, in the illustrated example, the container 100 has a substantially frusto-ellipsoid shape. Alternatively stated, the container 100 has an elliptic or oval shape when viewed in a direction of the vertical axis A₃ (see FIG. 4) and is truncated at a top 114 of the lid 112 and at a bottom 104 of the base 102. The base 102 and the lid 112 have complementing oblong shapes that define the shape of the container 100. In the illustrated example, the base 102 and the lid 112 each have a substantially hemi-ellipsoid shape and are truncated at the bottom 104 and the top 114, respectively. In some examples, the base 102 and the lid 112 are substantially the same size and shape to form a substantially mirror-image relative to planes respectively defined by the horizontal axes A₁ and A₂, the longitudinally horizontal axis A₁ and the vertical axis A₃, and the laterally horizontal axis A₂ and the vertical axis A₃. In other examples, the base 102 and the lid 112 have substantially the same shape but differ in at least one dimension or other geometrical characteristic (e.g., differ in a vertical dimension or height).

The base 102 and the lid 112 may be made of any suitable material. For example, the base 102 and the lid 112 may be made of resins or plastic materials including, but not limited to, polyethylene, polypropylene, polyvinyl chloride or polyethylene terephthalate (“PET”). The base 102 and the lid 112 may be thermoformed, blow-molded, or injection molded, or may be made using any other suitable technique. The base 102 and the lid 112 may be transparent or translucent, and may be colored or dyed in either instance. The base 102 and the lid 112 may be made of the same material or of a different material. In some examples, the base 102 and the lid 112 may be made integral from one sheet of material (e.g., one sheet of resin or plastic material).

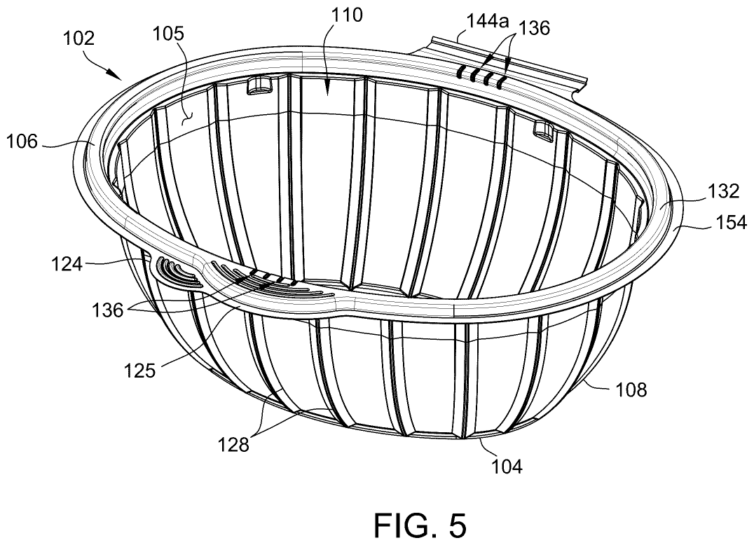

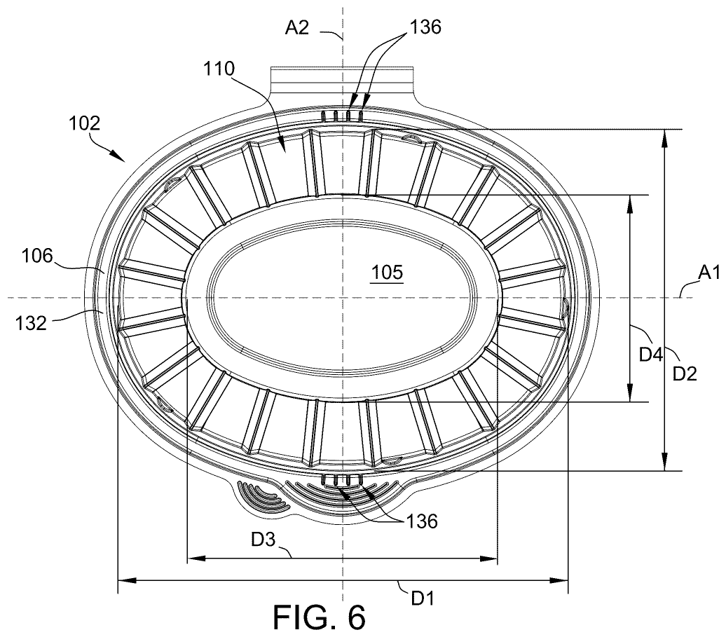

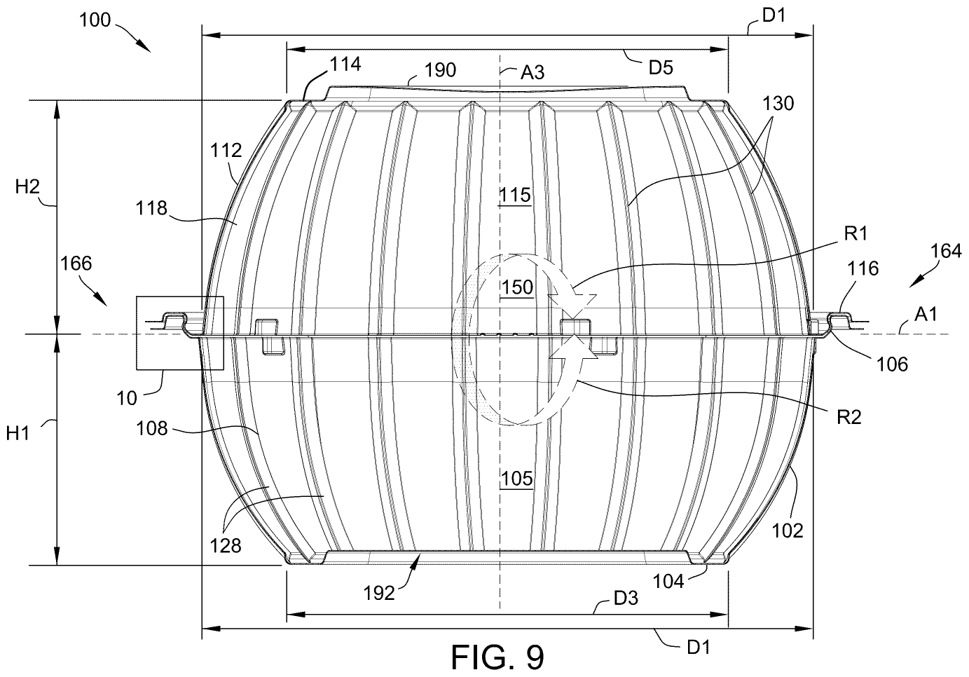

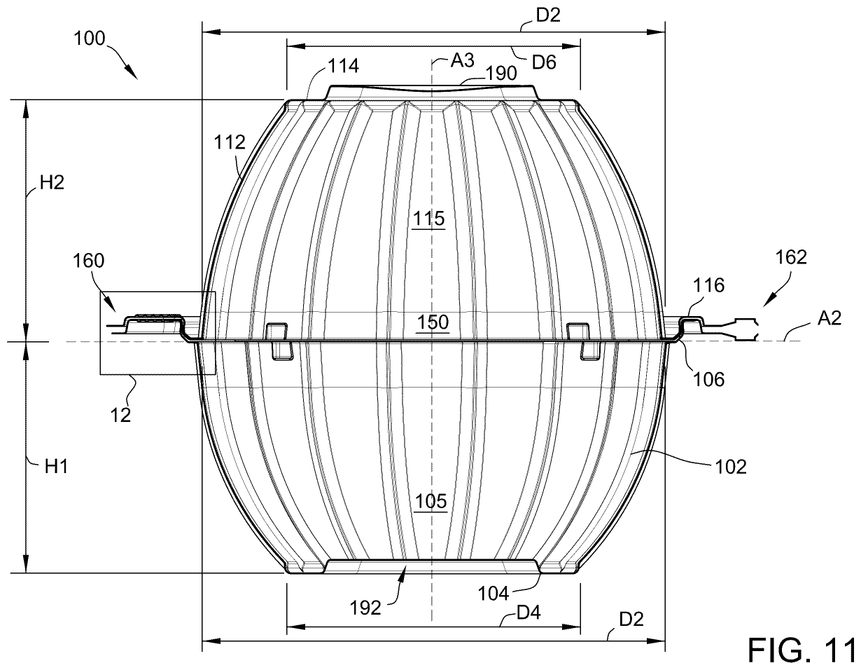

With additional reference to FIGS. 5 and 6, the base 102 includes the bottom 104, a base rim 106, and a base sidewall 108 extending between the bottom 104 and the base rim 106 in a direction of the vertical axis A₃. The base sidewall 108 defines a base mixing chamber 105, or base chamber 105. The base chamber 105 cooperatively defines a mixing chamber 150 of the container 100 (shown in FIGS. 9 and 11) with a lid mixing chamber 115 of the lid 112 when the container 100 is closed. The base rim 106 has an elliptic or oval shape and defines an elliptic-shaped opening 110 of the base 102. The base chamber 105 has two conjugate diameters D₁ and D₂ proximate the base opening 110. The diameter D₁ extends in a direction of the longitudinally horizontal axis A₁ and the diameter D₂ extends in a direction of the laterally horizontal axis A₂.

The elliptic shape of the base opening 110 is such that a ratio of D₁ to D₂ is greater than 1. The ratio of D₁ to D₂ may be any value greater than 1 that enables the container 100 to function as described herein. In certain examples, the ratio of D₁ to D₂ is greater than 1.1, or greater than 1.2. For example, the ratio of D₁ to D₂ is between about 1.1 to about 1.8, such as between about 1.2 to about 1.6, or between about 1.2 to about 1.4.

The base sidewall 108 is curved relative to the vertical axis A₃. The curve of the base sidewall 108 defines a concave shape as the base sidewall 108 extends between the base rim 106 and the bottom 104. The bottom 104 also has an elliptic or oval shape, and the base chamber 105 has two conjugate diameters D₃ and D₄ proximate the bottom 104. The diameter D₃ extends in the direction of the longitudinally horizontal axis A₁ and the diameter D₄ extends in the direction of the laterally horizontal axis A₂.

The elliptic shape of the bottom 104 of the base 102 is such that a ratio of D₃ to D₄ is greater than 1. The ratio of D₃ to D₄ may be any value greater than 1 that enables the container 100 to function as described herein. In certain examples, the ratio of D₃ to D₄ is greater than 1.1, or greater than 1.2. For example, the ratio of D₃ to D₄ is between about 1.1 to about 1.8, such as between about 1.2 to about 1.6, or between about 1.3 to about 1.6.

The curve of the base sidewall 108 is such that the base chamber 105 is tapered in diameter between the conjugate diameters D₁, D₂ proximate the base rim 106 and the conjugate diameters D₃, D₄ proximate the bottom 104. That is, as the base sidewall 108 curves relative to the vertical axis A₃ as the base sidewall 108 extends downwardly, a diameter of the base chamber 105 measured in the direction of the longitudinally horizontal axis A₁ tapers from the diameter D₁ to the diameter D₃ and a diameter of the base chamber 105 measured in the direction of the laterally horizontal axis A₂ tapers from the diameter D₂ to the diameter D₄. As such, the diameter D₁ is greater than the diameter D₃ and the diameter D₂ is greater than the diameter D₄.

In the illustrated example, the base sidewall 108 has a greater degree of curvature, relative to the vertical axis A₃, at laterally horizontal sides of the base 102 than at longitudinally horizontal ends of the base 102. The laterally horizontal sides of the base 102 are relative to the laterally horizontal axis A₂ and the longitudinally horizontal ends of the base 102 are relative to the longitudinally horizontal axis A₁. When the container 100 is formed, as shown in FIGS. 1-4, the laterally horizontal sides of the base 102 are located at laterally horizontal sides 160, 162 of the container 100 and the longitudinally horizontal ends of the base 102 are located at longitudinally horizontal ends 164, 166 of the container 100. The greater degree of curvature of the base sidewall 108 at the laterally horizontal sides translates to the ratio of D₁ to D₂ being smaller than the ratio of D₃ to D₄. That is, the base sidewall 108 is curved such that the diameter of the base chamber 105 has a greater taper between the diameters D₂ and D₄ than a taper between the diameters D₁ and D₃. In these examples, the ratio of D₁ to D₂ and the ratio of D₃ to D₄ are each independently greater than 1, with the proviso that the ratio of D₁ to D₂ is smaller than the ratio of D₃ to D₄. For example, the ratio of D₁ to D₂ is between about 1.1 to about 1.8, between about 1.2 to about 1.6, or between about 1.2 to about 1.4, and the ratio of D₃ to D₄ is between about 1.1 to about 1.8, between about 1.2 to about 1.6, or between about 1.3 to about 1.6, with the proviso that the ratio of D₁ to D₂ is smaller than the ratio of D₃ to D₄. In certain examples, the ratio of D₁ to D₂ is between about 1.2 to about 1.4, and the ratio of D₃ to D₄ is between about 1.3 to about 1.6, with the proviso that the ratio of D₁ to D₂ is smaller than the ratio of D₃ to D₄.

In other examples, the degree of curvature of the base sidewall 108 relative to the vertical axis A₃ may be substantially consistent, such that the ratio of D₁ to D₂ is approximately equal (e.g., within a range of +/−5%) to the ratio of D₃ to D₄. In some such examples, the ratio of D₁ to D₂ and the ratio of D₃ to D₄ are approximately equal and are each greater than 1, greater than 1.1, or greater than 1.2. In various examples, the ratio of D₁ to D₂ and the ratio of D₃ to D₄ are approximately equal and are each between about 1.1 to about 1.8, between about 1.2 to about 1.6, between about 1.2 to about 1.4, or between about 1.3 to about 1.6. The base sidewall 108 may have any suitable curvature to enable the container 100 to function as described herein. For example, the base sidewall 108 may have any suitable curvature such that ratio of D₁ to D₂ and the ratio of D₃ to D₄ are each independently greater than 1, greater than 1.1, or greater than 1.2, such as between about 1.1 to about 1.8, between about 1.2 to about 1.6, between about 1.2 to about 1.4, or between about 1.3 to about 1.6.

The base sidewall 108 extends a height H₁ between the bottom 104 and the base rim 106. The height H₁ translates to a depth of the base 102. The height H₁ is any suitable height that enables the container 100 to function as described. In particular, the height H₁ suitably translates to a sufficient depth of the base 102 to enable the contents of the container 100 to be contained therein. The height H₁ also enables the contents of the container 100 to move within the base chamber 105 during mixing, as described below. In the example container, the height H₁ is such that a ratio of H₁ to D₂ is between about 0.35 to about 0.75, such as between about 0.4 to about 0.6, between about 0.45 to about 0.55, between about 0.4 to about 0.5, or between about 0.5 to about 0.6. The ratio of H₁ to D₂ may be such that the container 100 is enabled to function as described herein, and also such that an overall size and footprint of the container 100 is limited. That is, the ratio of H₁ to D₂ may be any suitable ratio to enable the container 100 to function as described herein while also limiting size and footprint of the container 100 for improved usability (e.g., easier and more convenient handling, transporting, and storing).

The base rim 106 is configured for engagement with a lid rim 116 of the lid 112 to create a peripheral seal 152, as will be described below. The base rim 106 extends outwardly from the base sidewall 108 and includes an upwardly-extending bead 132 and a peripheral base rim flange 154, or base flange 154, that is outboard of the bead 132. A first hinge segment 144a extends from the base flange 154 and is connected with a second hinge segment 144b of the lid 112 to define the hinge 144 of the container 100. Although the hinge segments 144a, 144b are shown separated, in various examples the hinge segments 144a, 144b remain connected when the container 100 is opened such that the base 102 and the lid 112 do not fully separate. The hinge segment 144a is located at one of the laterally horizontal sides of the base 102, corresponding to the hinge 144 being located at the laterally horizontal side 162 of the container 100.

The base 102 also includes one or more tabs 124, 125 extending from the base flange 154. The tabs 124, 125 are located at the laterally horizontal side opposite the hinge segment 144a. As will be described in more detail below, the tabs 124, 125 cooperate with tabs 126, 127 of the lid 112 to enable the user to separate the lid 112 from the base 102 and open the container 100. Additionally, the tabs 124-127 are located on the laterally horizontal side 160 of the container 100 opposite the laterally horizontal side 162 at which the hinge 144 is located. The tabs 124-127 and the hinge 144 provide grips 122 from the user to manipulate the container 100 to mix the contents therein, described in more detail below.

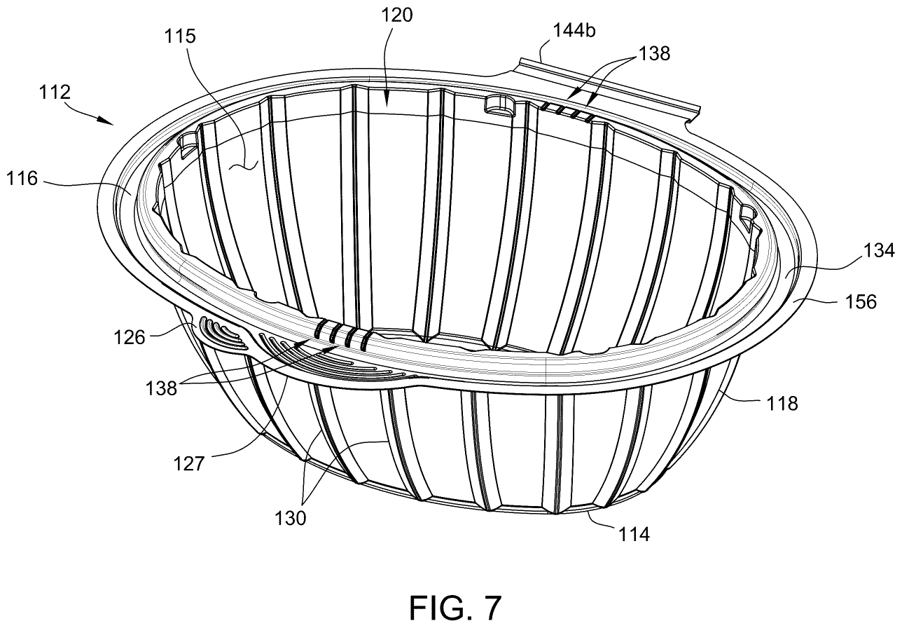

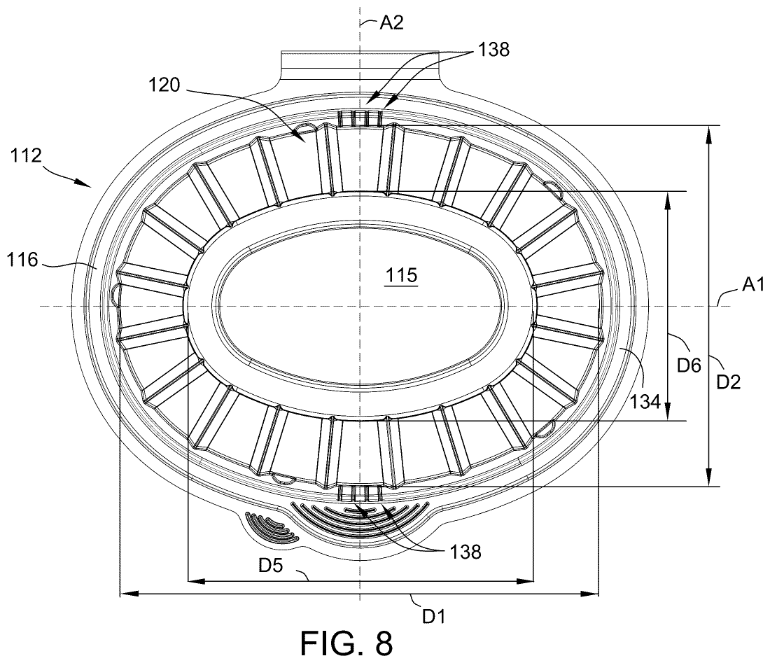

With additional reference to FIGS. 7 and 8, the lid 112 includes the top 114, the lid rim 116, and a lid sidewall 118 extending between the top 114 and the lid rim 116 in the direction of the vertical axis A₃. The lid sidewall 118 defines a lid mixing chamber 115, or lid chamber 115. The lid chamber 115 cooperates with the base chamber 105 to define the mixing chamber 150 of the container 100 (shown in FIGS. 9 and 11). The lid 112 is substantially similar in shape as the base 102. The lid rim 116, like the base rim 106, has an elliptic or oval shape and defines an elliptic-shaped opening 120 of the lid 112. The lid chamber 115, like the base chamber 105, has the two conjugate diameters D₁ and D₂ proximate the lid opening 120.

The diameters D₁ and D₂ of the lid chamber 115 proximate the lid opening 120 are as described above for the diameters D₁ and D₂ of the lid chamber 115 proximate the lid opening 120. That is, when the container 100 is formed, the mixing chamber 150 has the two conjugate diameters D₁ and D₂ at the intersection of the base rim 106 and the lid rim 116, as shown in FIGS. 9 and 11.

The lid sidewall 118, like the base sidewall 108, is curved relative to the vertical axis A₃. The curve of the lid sidewall 118 defines a concave shape as the lid sidewall 118 extends between the lid rim 116 and the top 114. The top 114 also has an elliptic or oval shape, and the lid chamber 115 has two conjugate diameters D₅ and D₆ proximate the top 114. The diameter D₅ extends in the direction of the longitudinally horizontal axis A₁ and the diameter D₆ extends in the direction of the laterally horizontal axis A₂.

Like the bottom 104 of the base 102 described above, the elliptic shape of the top 114 of the lid 112 is such that a ratio of D₅ to D₆ is greater than 1. The ratio of D₅ to D₆ may be any value greater than 1 that enables the container 100 to function as described herein. In certain examples, the ratio of D₅ to D₆ is greater than 1.1, or greater than 1.2. For example, the ratio of D₅ to D₆ is between about 1.1 to about 1.8, such as between about 1.2 to about 1.6, or between about 1.3 to about 1.6.

The curve of the lid sidewall 118 is such that the lid chamber 115 is tapered in diameter between the conjugate diameters D₁, D₂ proximate the lid rim 116 and the conjugate diameters D₅, D₆ proximate the top 114. That is, as the lid sidewall 118 curves relative to the vertical axis A₃ as the lid sidewall 118 extends upwardly, a diameter of the lid chamber 115 measured in the direction of the longitudinally horizontal axis A₁ tapers from the diameter D₁ to the diameter D₅ and a diameter of the lid chamber 115 measured in the direction of the laterally horizontal axis A₂ tapers from the diameter D₂ to the diameter D₆. As such, the diameter D₁ is greater than the diameter D₅ and the diameter D₂ is greater than the diameter D₆.

In the illustrated example, the lid sidewall 118, like the base sidewall 108, has a greater degree of curvature, relative to the vertical axis A₃, at laterally horizontal sides of the lid 112 than at longitudinally horizontal ends of the lid 112. The laterally horizontal sides of the lid 112 are relative to the laterally horizontal axis A₂ and the longitudinally horizontal ends of the lid 112 are relative to the longitudinally horizontal axis A₁. When the container 100 is formed, as shown in FIGS. 1-4, the laterally horizontal sides of the lid 112 are located at the laterally horizontal sides 160, 162 of the container 100 and the longitudinally horizontal ends of the lid 112 are located at the longitudinally horizontal ends 164, 166 of the container 100. The greater degree of curvature of the lid sidewall 118 at the laterally horizontal sides translates to the ratio of D₁ to D₂ being smaller than the ratio of D₅ to D₆. That is, the lid sidewall 118 is curved such that the diameter of the lid chamber 115 has a greater taper between the diameters D₂ and D₆ than a taper between the diameters D₁ and D₅. In these examples, the ratio of D₁ to D₂ and the ratio of D₅ to D₆ are each independently greater than 1, with the proviso that the ratio of D₁ to D₂ is smaller than the ratio of D₅ to D₆. For example, the ratio of D₁ to D₂ is between about 1.1 to about 1.8, between about 1.2 to about 1.6, or between about 1.2 to about 1.4, and the ratio of D₅ to D₆ is between about 1.1 to about 1.8, between about 1.2 to about 1.6, or between about 1.3 to about 1.6, with the proviso that the ratio of D₁ to D₂ is smaller than the ratio of D₅ to D₆. In certain examples, the ratio of D₁ to D₂ is between about 1.2 to about 1.4, and the ratio of D₅ to D₆ is between about 1.3 to about 1.6, with the proviso that the ratio of D₁ to D₂ is smaller than the ratio of D₅ to D₆.

In other examples, the degree of curvature of the lid sidewall 118 relative to the vertical axis A₃ may be substantially consistent, such that the ratio of D₁ to D₂ is approximately equal (e.g., within a range of +/−5%) to the ratio of D₅ to D₆. In some such examples, the ratio of D₁ to D₂ and the ratio of D₅ to D₆ are approximately equal and are each greater than 1, greater than 1.1, or greater than 1.2. In various examples, the ratio of D₁ to D₂ and the ratio of D₅ to D₆ are approximately equal and are each between about 1.1 to about 1.8, between about 1.2 to about 1.6, between about 1.2 to about 1.4, or between about 1.3 to about 1.6. The lid sidewall 118 may have any suitable curvature to enable the container 100 to function as described herein. For example, the lid sidewall 118 may have any suitable curvature such that ratio of D₁ to D₂ and the ratio of D₅ to D₆ are each independently greater than 1, greater than 1.1, or greater than 1.2, such as between about 1.1 to about 1.8, between about 1.2 to about 1.6, between about 1.2 to about 1.4, or between about 1.3 to about 1.6.

The lid sidewall 118 extends a height H₂ between the lid rim 116 and the top 114. The height H₂ translates to a depth of the lid 112. The height H₂ is any suitable height that enables the container 100 to function as described. In particular, the height H₂ suitably translates to a sufficient depth of the lid 112 to enable the contents of the container 100 to be contained therein. The height H₂ also enables the contents of the container 100 to move within the lid chamber 115 during mixing, as described below. In the example container, the height H₂ is such that a ratio of H₂ to D₂ is between about 0.35 to about 0.75, such as between about 0.4 to about 0.6, between about 0.45 to about 0.55, between about 0.4 to about 0.5, or between about 0.5 to about 0.6. The ratio of H₂ to D₂ may be such that the container 100 is enabled to function as described herein, and also such that an overall size and footprint of the container 100 is limited. That is, the ratio of H₂ to D₂ may be any suitable ratio to enable the container 100 to function as described herein while also limiting size and footprint of the container 100 for improved usability (e.g., easier and more convenient handling, transporting, and storing).

In some examples, the lid sidewall 118 has substantially the same dimensions as the base sidewall 108, such that the base 102 and the lid 112 are substantially the same in size and shape. For example, the height H₁ of the base sidewall 108 may be approximately equal (e.g., within a range of +/−5%) to the height H₂ of the lid sidewall 118. The approximately equal heights H₁ and H₂ translates to approximately equal depths of the base chamber 105 and the lid chamber 115. In some examples, the base chamber 105 and the lid chamber 115 may have approximately the same dimensions such that the mixing chamber 150 is substantially mirror-imaged relative to planes respectively defined by the horizontal axes A₁ and A₂, the longitudinally horizontal axis A₁ and the vertical axis A₃, and the laterally horizontal axis A₂ and the vertical axis A₃. In such examples, the base sidewall 108 and the lid sidewall 118 also have the same curvature profile such that H₁ is approximately equal (e.g., within a range of +/−5%) to H₂, the ratio of D₁ to D₂ is smaller than each of the ratio of D₃ to D₄ and the ratio of D₅ to D₆, and the ratio of D₃ to D₄ is approximately equal (e.g., within a range of +/−5%) to the ratio of D₅ to D₆.

In alternative examples, the lid sidewall 118 has at least one dimension or geometrical characteristic that differs from the base sidewall 108. For example, the height H₁ of the base sidewall 108 may be different from the height H₂ of the lid sidewall 118. Additionally or alternatively, the base sidewall 108 and the lid sidewall 118 have different curvature profiles. In such examples, H₁ is different from H₂, and/or the ratio of D₃ to D₄ is different from the ratio of D₅ to D₆. In these examples, the heights H₁ and H₂ and the ratios D₃ to D₄ and D₅ to D₆ may be any suitable value to enable the container 100 to function as described herein. For example, the ratio of D₁ to D₂ and the ratio of D₅ to D₆ are each independently greater than 1, greater than 1.1, or greater than 1.2, such as between about 1.1 to about 1.8, between about 1.2 to about 1.6, between about 1.2 to about 1.4, or between about 1.3 to about 1.6, and the ratio of H₁ to D₂ and the ratio of H₂ to D₂ are each independently between about 0.35 to about 0.75, such as between about 0.4 to about 0.6, between about 0.45 to about 0.55, between about 0.4 to about 0.5, or between about 0.5 to about 0.6.

The lid rim 116 is configured for engagement with the base rim 106 of the base 102 to create the peripheral seal 152, as will be described below. The lid rim 116 extends outwardly from the lid sidewall 118 and includes a trough 134, or an upward-extending cavity, and a peripheral lid flange 156 that is outboard of the trough 134. The trough 134 receives the bead 132 when the peripheral seal 152 is created. The second hinge segment 144b extends from the lid flange 156 and connects with the first hinge segment 144a of the base 102 to define the hinge 144 of the container 100. As described above, although the hinge segments 144a, 144b are shown separated, in various examples the hinge segments 144a, 144b remain connected when the container 100 is opened such that the base 102 and the lid 112 do not fully separate. The hinge segment 144b is located at one of the laterally horizontal sides of the lid 112, corresponding to the hinge 144 being located at the laterally horizontal side 162 of the container 100.

The lid 112 also includes one or more tabs 126, 127 extending form the lid flange 156. The tabs 126, 127 are located at the laterally horizontal side opposite the hinge segment 144b. When the container 100 is formed, the tab 127 of the lid 112 overlaps the tab 125 of the base 102 to define a central gripping tab 146 at the laterally horizontal side 160 of the container 100. The tabs 124, 126 of the base 102 and the lid 112, respectively, are offset at the laterally horizontal side 160, on opposite sides of the gripping tab 146. The user is enabled to separate the lid 112 from the base 102 using the offset tabs 124, 126, as well as the tabs 125, 127 upon separating them from one another, to open the container 100. The tabs 124-127 are each suitably sized and shaped for a lateral grasp by a hand of the user, to enable the user to easily and comfortably open the container 100 by separating the lid 112 from the base 102. The tabs 124-127 may also include treads 170 (e.g., bumps) for a more reliable grasp.

The tabs 124-127 are located on the laterally horizontal side 160 of the container 100 opposite the laterally horizontal side 162 at which the hinge 144 is located. The tabs 124-127 and the hinge 144 each provide a grip 122 for the user to rotate the container 100 to mix the contents therein. The grips 122 are each sized, shaped, and positioned to be grasped by a hand of a user for manually mixing the contents within the mixing chamber 150 by rotating the container about the laterally horizontal axis A₂. In particular, the grips 122 are located at the laterally horizontal sides 160, 162 of the container 100 to enable the user to rotate the container 100 about the laterally horizontal axis A₂ and the grips 122 are sized and shape for a lateral grasp by a hand of the user to enable the user to easily and comfortably rotate the container 100.

In a manual mixing operation using the container 100, the container 100 is rotated by a user using the grips 122 about the laterally horizontal axis A₂. Rotation of the container 100 about the axis A₂ may reciprocate between a forward rotational direction R₁ and a backward rotational direction R₂ (shown in FIGS. 2 and 9). The container 100 is dimensioned to facilitate mixing the contents in the mixing chamber 150 using this rotational movement. This facilitates improving the manual mixing operation, avoiding excessive effort and awkward movement to mix the contents, and ensures a consistent and repeatable manual mixing method using the container 100. In particular, the mixing chamber 150 of the container 100 is sized such that, during rotation of the container 100 about the laterally horizontal axis A₂, the contents reciprocate between the base chamber 105 and the lid chamber 115. The contents remain centered relative to a plane defined by the longitudinally horizontal axis A₁ and the vertical axis A₃ due to the ratio of the conjugate diameters D₁ and D₂, D₃ and D₄, and D₅ and D₆. That is, radially outward movement of the contents in the mixing chamber, relative to the plane defined by the axes A₁ and A₃, is limited by the smaller of the two of each pair of conjugate diameters, that is, by the diameters D₂, D₄, and D₆. Concurrently, reciprocating movement of the contents between the base chamber 105 and the lid chamber 115 is enabled by the heights H₁ and H₂ as the container 100 is rotated about the laterally horizontal axis A₂. As a result, enhanced mixing of the contents is achieved without the user having to shake the container, or rotate the container about axes other than the laterally horizontal axis A₂. Additionally, after mixing, the curvature profiles of the base sidewall 108 and the lid sidewall 118 enable the contents to pool downward in the direction of the vertical axis A₃.

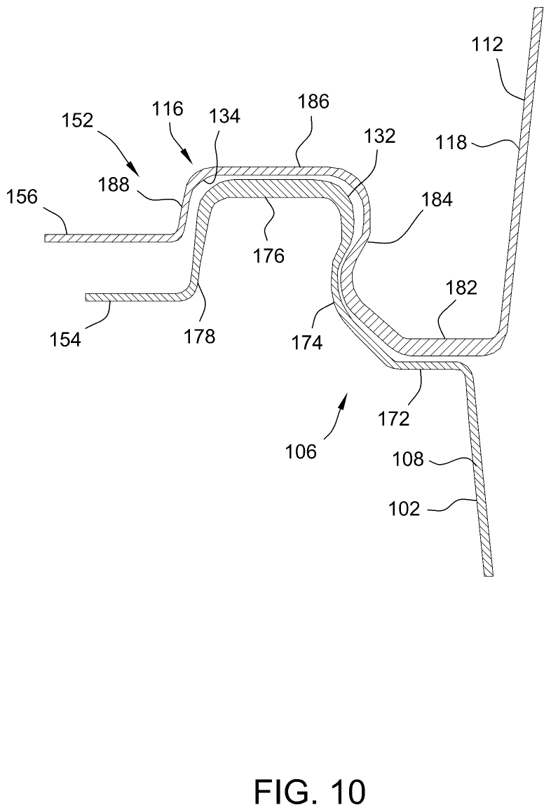

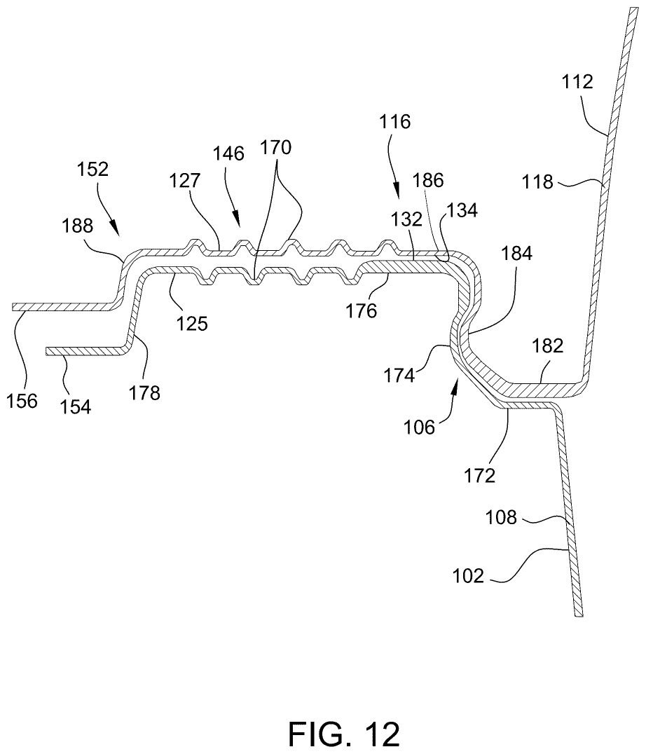

Referring now to FIGS. 9-12, the lid rim 116 and the base rim 106 engage to create a continuous peripheral seal 152 when the container 100 is formed. FIG. 10 depicts engagement between the lid rim 116 and the base rim 106 at the longitudinally horizontal end 166 of the container 100. FIG. 12 depicts engagement between the lid rim 116 and the base rim 106 at the longitudinally horizontal side 162 where the tabs 124, 125 are located and overlap to form the central gripping tab 146. The peripheral seal 152 extends continuously, that is, uninterrupted, along the periphery of the container 100.

The peripheral seal 152 is created by the bead 132 of the base rim 106 being received by the trough 134 of the lid rim 116. The bead 132 extends upwardly from a proximal segment 172 of the base rim 106. The base rim proximal segment 172 extends outwardly from the base sidewall 108 to the bead 132. The bead includes an S-shaped wall 174 extending upwardly from the base rim proximal segment 172 to a middle segment 176 of the bead 132. The bead 132 also includes an outer wall 178 that extends between the middle bead segment 176 and the base rim flange 154. As shown in FIG. 12, the tab 125 of the base 102 lengthens a distance spanned by the middle segment 176 of the bead 132 between the S-shaped wall 174 and the outer wall 178.

The trough 134 defines an upwardly-extending cavity that complements a shape of the bead 132. The trough 134 includes an S-shaped wall 184 that extends upwardly from a proximal segment 182 of the lid rim 116. The lid rim proximal segment 182 extends outwardly from the lid sidewall 118 to the S-shaped wall 184. The S-shaped wall 184 extends upwardly from the lid rim proximal segment 182 to a middle segment 186 of the trough 134. The trough 134 also includes an outer wall 188 that extends between the middle trough segment 186 and the lid rim flange 156. As shown in FIG. 12, the tab 127 of the lid 112 lengthens a distance spanned by the middle segment 186 of the trough 134 between the S-shaped wall 184 and the outer wall 188.

As shown in FIGS. 9-12, when the container 100 is formed, the bead 132 is received by the trough 134 such that the S-shaped walls 174, 184 engage by friction to create the continuous peripheral seal 152. The magnified views of FIGS. 10 and 12 depict a small gap between the bead 132 and the trough 134, and more generally between the rims 106, 116, but this is for convenience of illustration. When the container 100 is formed, one or more surfaces of the base rim 106 is in face-to-face contact with one or more surfaces of the lid rim 116. For example, the middle segments 176, 186 of the bead 132 and trough 134 and/or the proximal segments 172, 182 of the base rim 106 and lid rim 116 are in face-to-face contact. The frictional engagement between the S-shaped walls 174, 184 facilitates preventing the container 100 from becoming prematurely opened, and such frictional engagement along with the face-to-face contact between the middle segments 176, 186 and the proximal segments 172, 182 creates a substantially liquid-tight seal 152 along the periphery of the container 100.

Referring to FIGS. 10 and 12, the base rim 106 and the lid rim 116 also include complementing material distribution or thickness profiles that facilitates creating a “ball and socket” joint at the peripheral seal 152. The ball and socket peripheral seal 152 may be easier to create and/or more reliable to limit or prevent the container 100 from prematurely opening. The lid rim 116 has a relatively greater thickness at the proximal segment 182 and a portion of the S-shaped wall 184 proximate the proximal segment 182. The thickness of the lid rim 116 is relatively smaller along the S-shaped wall 184 proximate the middle trough segment 186 and along the middle trough segment 186. Correspondingly, the base rim 106 has a relatively smaller thickness at the proximal segment 172 and a portion of the S-shaped wall 174 proximate the proximal segment 172, and the thickness of the base rim 106 is relatively greater along the S-shaped wall 174 proximate the middle bead segment 176 and along the middle bead segment 176. As a result, as shown in FIGS. 10 and 12, the relatively thicker portions of the base rim 106, and more particularly the thicker portions of the bead 132, engage the relatively thinner portions of the S-shaped wall 184 and middle trough segment 186. The relatively thicker portions of the lid rim 116, and more particularly the thicker portions of the S-shaped wall 184 and the proximal segment 182, engage the relatively thinner portions of the base rim 106. The base rim 106 articulates at the thinner portions of the proximal segment 172 and the S-shaped wall 174 relative to the lid rim 116 when the rims 106, 116 engage to close the container 100, enabling the bead 132 to be received by the trough 134. When the peripheral seal 152 is formed, the thicker portions of the S-shaped wall 184 and the proximal segment 182 of the lid rim 116 are located below, and provide rigidity and support to, the thicker portions of the base rim 106.

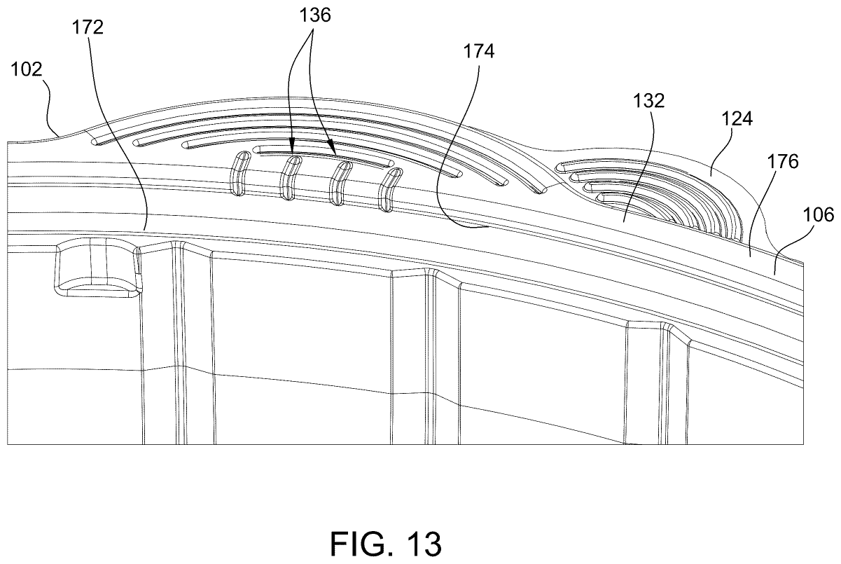

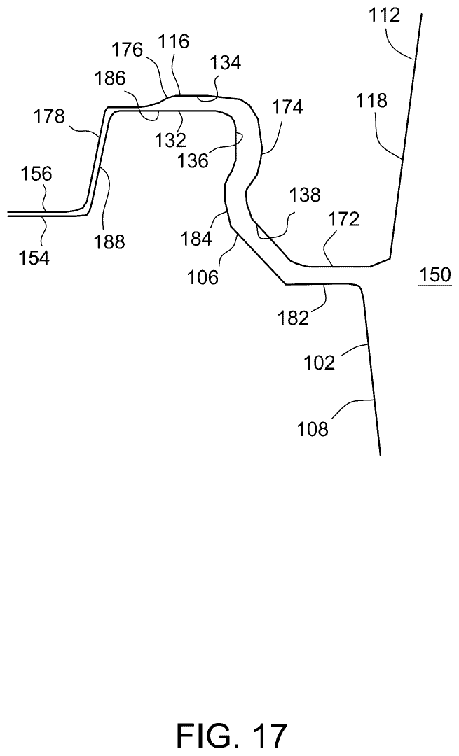

Referring to FIGS. 13-16, the base rim 106 includes two series of vent channels 136 and the lid rim 116 includes two series of vent channels 138. The vent channels 136, 138 are narrow grooves formed in the rims 106, 116 and terminating prior to the peripheral edge of the middle segments 176, 186. The vent channels 136 of the base rim 106 each align with one of the series of vent channels 138 of the lid rim 116, creating vent paths between the engaged rims 106, 116 (shown in FIG. 17) that enables heat and steam to exit the mixing chamber 150 of the container 100 when closed while preventing or limiting leakage of the contents. Each series of vent channels 136, 138 may include any suitable number of vent channels, such as one vent channel, two vent channels, three vent channels, four vent channels, five vent channels, six vent channels, seven vent channels, eight vent channels, nine vent channels, ten vent channels, or more than ten vent channels. In the illustrated example, each series of vent channels 136, 138 includes four vent channels. In another example, each series of vent channels 136, 138 includes two vent channels. The series of vent channels 136, 138 are located at the laterally horizontal sides 160, 162 of the container 100 when formed. In other examples, the vent channels 136, 138 may be at any suitable location to enable the vent channels to function as described. In some examples, the vent channels 136 may be included in the base rim 106 while the vent channels 138 are omitted from the lid rim 116, or the vent channels 138 may be included in the lid rim 116 while the vent channels 136 are omitted from the base rim 106.

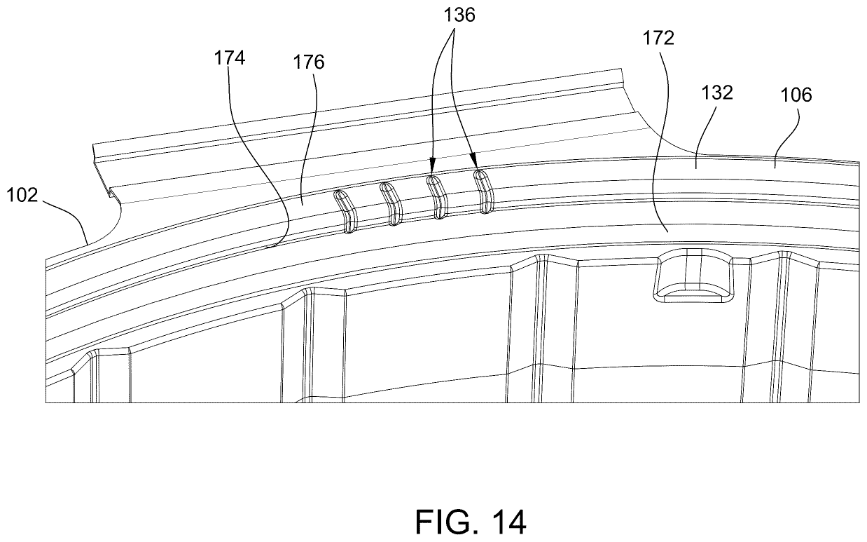

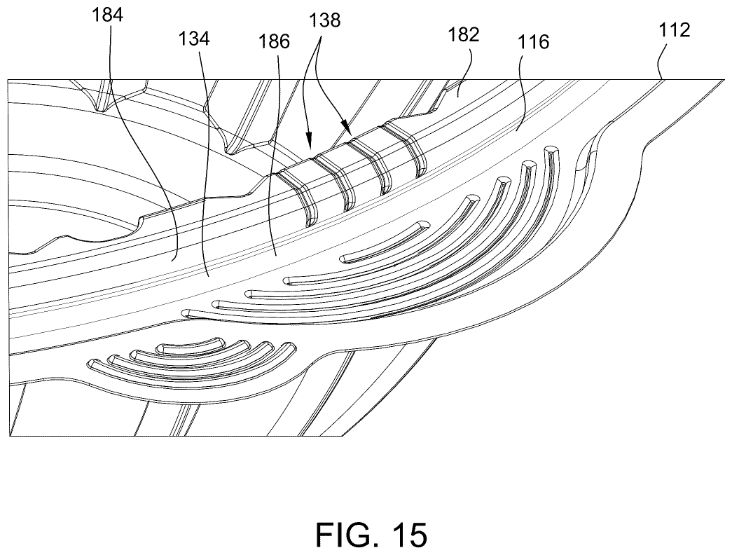

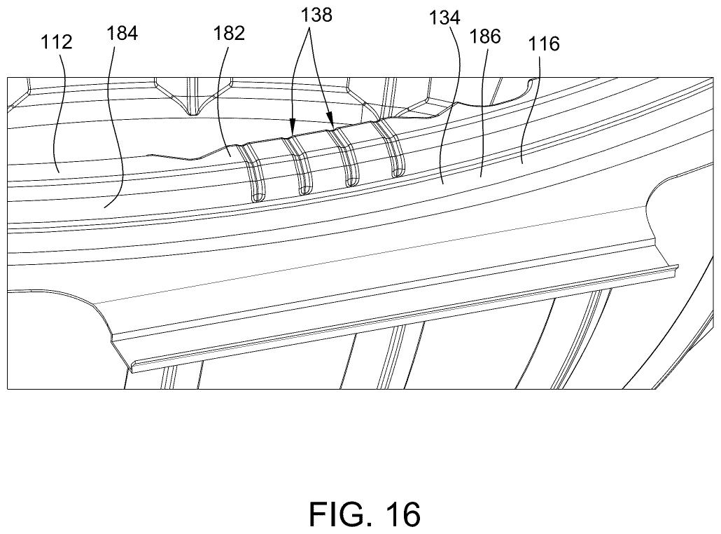

As shown in FIGS. 13 and 14, each vent channel 136 of the base rim 106 extends upwardly along the S-shaped wall 174 of the bead 132 and outwardly along the middle segment 176 of the bead 132. The vent channels 136 terminate prior to a peripheral edge of the bead 132, that is, prior to an intersection of the middle segment 176 of the bead 132 and the outer wall 178 of the bead 132. As shown in FIGS. 15 and 16, each vent channel 138 of the lid rim 116 extends outwardly from the lid sidewall 118 and downwardly along the S-shaped wall 184 of the trough 134. The vent channels 138 terminate along the S-shaped wall 184, prior to the middle segment 186 of the trough 134. When the container 100 is formed, each of the vent channels 136 of the base 106 aligns with one of the vent channels 138 of the lid 112. FIG. 17 schematically depicts alignment between a pair of vent channels 136, 138. As shown in FIG. 17, each aligned pair of vent channels 136, 138 is in fluid communication with the mixing chamber 150, allowing heat and steam to flow into the aligned pair of vent channels 136, 138. The aligned pair of vent channels 136, 138 also terminates prior to an outer edge of the peripheral seal 152, to allow heat and steam to vent from the mixing chamber 150 while limiting leakage of the contents from the container 100. Suitably, the engagement between the rims 106, 116 when the container 100 is closed maintains sufficient face-to-face contact between the middle segments 176, 186 of the bead 132 and trough 134, radially outboard of a terminus of the vent channels 136, 138, to create a liquid seal therebetween, while also allowing for some separation between the rims 106, 116 to enable heat and steam to exit the container 100 through the vent channels 136, 138.

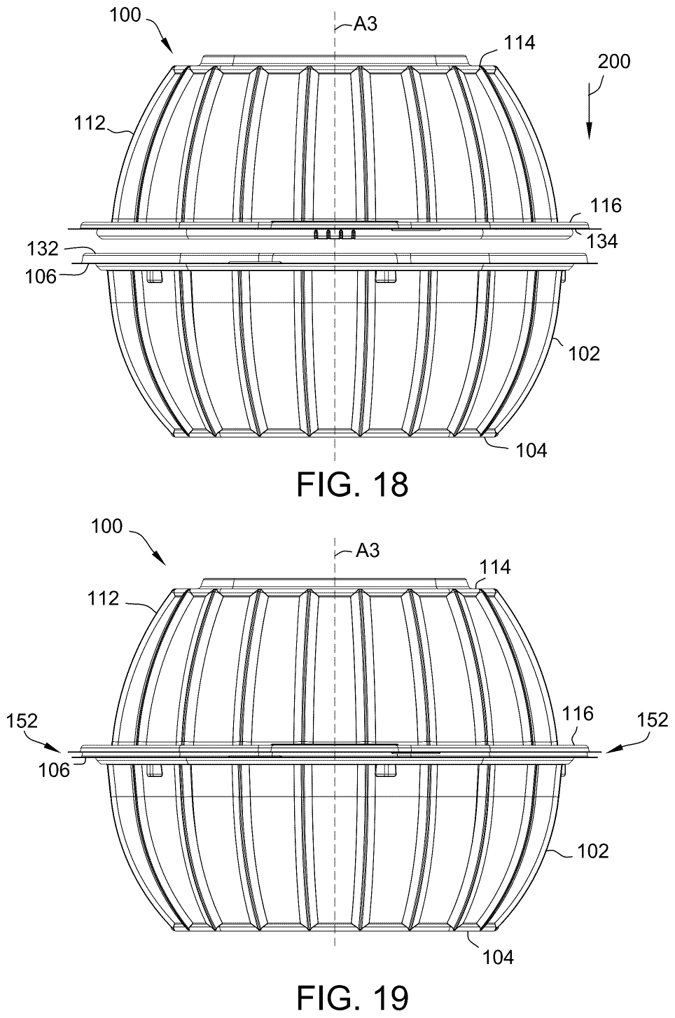

Referring to FIGS. 18 and 19, the elliptic shape of the base rim 106 and the lid rim 116 enable a single motion (or one step) closure of the lid 112 and the base 102 when forming the container via a downward force 200 applied to the lid 112 in the direction of the vertical axis A₃. In particular, when forming the container 100, the elliptic shape of the rims 106, 116 allows the lid rim 116 to be seated on the base rim 106 and then the user can push downward on the lid 112 to apply the downward force 200 to the lid 112 and create the peripheral seal 152 in a single motion or in one step. Each of the lid sidewall 118 and the base sidewall 108 also include structural ribs 128, 130, respectively, that extend in the direction of the vertical axis A₃. The structural ribs 128, 130 provide strength to the sidewalls 108, 118, allowing the sidewalls to withstand the downwardly applied force when closing the container 100. In the illustrated example, each structural rib 128, 130 is V-shaped and extends outwardly from the respective sidewall 108, 118. The V-shape of the structural ribs 128, 130 causes the ribs 128, 130 to taper to a reduced surface area at a terminal outer point of the ribs. The reduced surface area of the terminal outer points of the ribs 128, 130 provides an additional advantage of reducing or minimizing transfer of heat between the components within the container 100 and the hands of the user when the container 100 is held. In particular, the user is able to handle the container 100 using the ribs, which reduce or minimize the surface area contact between one or both sidewalls 108, 118 and the hands of the user. It will be appreciated that the illustrated sequence in FIGS. 18 and 19 is provided for illustrative purposes only. The lid 112 may be seated on the base 102 by rotating the lid 112 relative to the base 102 via the hinge 144, and the downward force 200 may then be applied to create the peripheral seal 152.

Additionally, the structural ribs 128, 130 increase a load capacity of the container 100 such that multiple containers 100 can be stacked on top of one another. The container 100 also includes stacking features that enable stacking multiple containers. In the illustrated example, the top 114 of the lid 112 includes a raised stacking platform 190 and the bottom 104 of the base 102 includes a stacking indent 192. The stacking platform 190 and indent 192 have complementary shapes (e.g., complementary oval or elliptic shapes) that enable the stacking platform 190 of a first container 100 to be received by the stacking indent 192 of a second container 100 stacked on the first container, with the bottom 104 of the second container 100 stacked on the top 114 of the first container 100. The raised stacking platform 190 also has a concave surface contour. The concave surface contour of the raised stacking platform 190 may provide an additional structural advantage in allowing the user to apply the downward force 200 to close the container 100 via a single motion closure without the top 114 collapsing inwardly. Additionally, the concave surface contour of the raised stacking platform 190 may allow the top 114 to deflect in the direction of the vertical axis A₃ in response to changes in temperature and pressure within the mixing chamber, which reduces strain on the lid 112.

Referring generally to FIGS. 1-19, a method of using the container 100, and in particular a method of mixing contents in the mixing chamber 150 using the container 100, includes placing contents within the base chamber 105 when the container 100 is open and then forming or closing the container 100 by engaging the lid rim 116 and the base rim 106 to enclose the contents within the base chamber 105 and the lid chamber 115. The lid rim 116 and the base rim 106 engage as described above to form the continuous peripheral seal 152. When the container 100 is closed, the grips 122 are located at the laterally horizontal sides 160, 162. To close the container 100, the user can seat the lid rim 116 on the base rim 106 and apply a single downward force 200 to the lid 112 in the direction of the vertical axis A₃ to create the continuous peripheral seal 152. Advantageously, the container 100 can be closed using a single applied downward force 200 due to the elliptic shape of the rims 106, 116, and the structural ribs 128, 130 that provide greater load resistance and rigidity to the sidewalls 108, 118 to enable the single motion closure.

The method also includes manually mixing the contents in the mixing chamber by rotating the container 100 about the laterally horizontal axis A₂, and in particular by reciprocating rotation of the container 100 about the axis A₂ between the forward rotational direction R₁ and the backward rotational direction R₂ (shown in FIGS. 2 and 9). Suitably, the user rotates the container 100 about the laterally horizontal axis A₂ using the grips 122 each located at one of two laterally horizontal sides 160, 162 of the container 100. During rotation of the container 100 about the axis A₂, the contents reciprocate between the base chamber 105 and the lid chamber 115. The reciprocating movement of the contents between the chambers 105, 115 is enabled by the heights H₁ and H₂, which respectively define a depth of the base 102 and the lid 112. The contents are centered during rotation of the container 100 about the axis A₂ relative to the plane defined by the axes A₁ and A₃. The centering of the contents about this plane is enabled by the ratios of the ratio of the conjugate diameters D₁ and D₂, D₃ and D₄, and D₅ and D₆ as described above. The centering of the contents and the reciprocating movement thereof results in enhanced mixing of the contents without the user having to shake the container, or rotate the container about axes other than the laterally horizontal axis A₂. After mixing, the curvature profiles of the base sidewall 108 and the lid sidewall 118 enable the contents to pool downward in the direction of the vertical axis A₃.

The above-described embodiments described herein relate to containers that can be used to transport, store, and manually mixing contents therein. The example containers can be used in various applications, including, for example, for applying sauce to chicken wings and mixing salad with dressing. The example containers are sized to improve or enhance mixing of the contents therein during rotation about a single axis. In particular, the example containers have a frusto-ellipsoid shape, with a mixing chamber of the container defining two conjugate diameters at a center thereof having a diameter ratio greater than 1. The greater diameter at the center of the mixing chamber extends about a longitudinally horizontal axis and the smaller diameter at the center of the mixing chamber extends about a laterally horizontal axis. The container is rotated about the laterally horizontal axis, and the smaller diameter facilitates limiting or reducing a deviation of the contents from a central longitudinal plane. This keeps the contents centered in the container during rotation for enhanced mixing. The mixing chamber of the container is also defined by two chambers of the lid and the base of the container, which are each sized for reciprocating movement of the contents therebetween during rotation for better mixing. The sidewalls of the lid and the base are each curved, which enables the contents to pool downward in the container after mixing, and the curvature profiles of the sidewalls results in the conjugate diameters of the mixing chamber being tapered towards the top and the bottom of the container. The tapered diameters of the mixing chamber allow for enhanced mixing by further keeping the contents centered relative to the longitudinal plane during rotation.

Advantages provided by the above-described embodiments described herein may include, but are not limited to only including: (i) improving or enhancing manual mixing of contents within a container while reducing the amount of effort and awkward movement required for mixing, (ii) ensuring a consistent and repeatable manual mixing method using the container, (iii) reducing a size or footprint of the container without sacrificing the ability to achieve sufficient mixing of the contents therein, (iv) providing grips on the container to allow the user to rotate the container in the appropriate rotational directions for mixing, (v) providing an easy and efficient way of closing the container using a single motion, downward force which is enabled by the elliptic shaped rims of the base and lid and structural ribs of the lid and base sidewalls, (vi) allowing steam and heat to vent from the container while reducing or preventing leakage of the contents from the container using vent channels that extend only partially through the closure of the engaging lid rim and base rim, (vii) allowing for multiple containers to be stacked on top of one another using complementing stacking features at the top and bottom of the container and the structural ribs for increasing stacking load capacity of the container, (viii) shaping the structural ribs such that the user can handle the container while the heat transfer surface area contact between the container and the user's hands is reduced or minimized, and/or (ix) strategically positioning the tabs of the container used for opening the container and the hinge of the container used for keeping the lid and base attached with the container is opened at strategic locations and with a suitable size and shape such that the tabs and the hinge can each be laterally grasped by a hand of the user and used to easily and comfortably rotate the container in the appropriate directions for mixing. Additional advantages will be apparent to those skilled in the art from the above-description of example embodiments.

As used herein, an element or step recited in the singular and preceded by the word “a” or “an” should be understood as not excluding plural elements or steps, unless such exclusion is explicitly recited. References to “example embodiment” or “one embodiment” are not intended to be interpreted as excluding the existence of additional embodiments that also incorporate the recited features. Moreover, although specific features of various embodiments described herein may be shown in some drawings and not in others, this is for convenience only. In accordance with the principles of the present disclosure, any feature of a drawing and/or embodiment described herein may be referenced and/or claimed in combination with any feature of any other drawing and/or embodiment described herein. Furthermore, unless explicitly stated to the contrary, embodiments “including” or “having” an element or a plurality of elements having a particular property may include additional such elements not having that property.

Unless otherwise indicated, approximating language, such as “generally,” “substantially,” “approximately,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value.

Unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A container for manually mixing contents therein, the container when formed having a first longitudinally horizontal axis A₁, a second laterally horizontal axis A₂, and a vertical axis A₃ that is perpendicular to the horizontal axes A₁ and A₂, the container comprising:
a base including a bottom, a base rim, and a base sidewall extending between the bottom and the base rim in a direction of the vertical axis A₃ and defining a base chamber, wherein the base rim defines an elliptic-shaped base opening, wherein the base chamber has two conjugate diameters D₁ and D₂ proximate the base opening and two conjugate diameters D₃ and D₄ proximate the bottom, wherein the diameters D₁ and D₃ extend in a direction of the longitudinally horizontal axis A₁ and the diameters D₂ and D₄ extend in a direction of the laterally horizontal axis A₂, and wherein a ratio of D₁ to D₂ is greater than 1 and a ratio of D₃ to D₄ is greater than 1;
a lid including a top, a lid rim, and a lid sidewall extending between the lid rim and the top in the direction of the vertical axis A₃ and defining a lid chamber, wherein the lid rim engages the base rim when the container is formed and defines an elliptic-shaped lid opening, wherein the lid chamber has the two conjugate diameters D₁ and D₂ proximate the lid opening and two conjugate diameters D₅ and D₆ proximate the top, wherein the diameter D₅ extends in the direction of the longitudinally horizontal axis A₁ and the diameter D₆ extends in the direction of the laterally horizontal axis A₂, and wherein a ratio of D₅ to D₆ is greater than 1; and
grips extending outwardly from the container when formed, each grip sized, shaped, and positioned to be grasped by a hand of a user for manually mixing the contents within the base and lid chambers by rotating the container about the laterally horizontal axis A₂.

2. The container of claim 1, wherein the ratio of D₁ to D₂, the ratio of D₃ to D₄, and the ratio of D₅ to D₆ facilitate centering the contents within the base and lid chambers relative to a plane defined by the longitudinally horizontal axis A₁ and the vertical axis A₃ during rotation of the container about the laterally horizontal axis A₂.

3. The container of claim 1, wherein the ratio of D₁ to D₂, the ratio of D₃ to D₄, and the ratio of D₅ to D₆ are each independently between 1.2 to 1.6.

4. The container of claim 1, wherein the lid and base sidewalls are curved relative to the vertical axis A₃ to enable the contents to pool downward in the direction of the vertical axis A₃ after mixing.

5. The container of claim 4, wherein the lid and base sidewalls each has a greater degree of curvature, relative to the vertical axis A₃, at laterally horizontal sides of the container than at longitudinally horizontal ends of the container, such that the ratio of D₁ to D₂ is smaller than each of the ratio of D₃ to D₄ and the ratio of D₅ to D₆.

6. The container of claim 1, wherein the ratio of D₁ to D₂ is between 1.2 to 1.4, and the ratio of D₃ to D₄ and the ratio of D₅ to D₆ are each independently between 1.3 to 1.6, with the proviso that the ratio of D₁ to D₂ is smaller than each of the ratio of D₃ to D₄ and the ratio of D₅ to D₆.

7. The container of claim 1, wherein the base sidewall extends a height H₁ between the bottom and the base rim and the lid sidewall extends a height H₂ between the lid rim and the top, wherein the heights H₁ and H₂ are sized to enable reciprocating movement of the contents between the base and lid chambers in the direction of the vertical axis A₃.

8. The container of claim 7, wherein H₁ is approximately equal to H₂, the ratio of D₁ to D₂ is smaller than each of the ratio of D₃ to D₄ and the ratio of D₅ to D₆, and the ratio of D₃ to D₄ is approximately equal to the ratio of D₅ to D₆.

9. The container of claim 7, wherein a ratio of H₁ to D₂ and a ratio of H₂ to D₂ are each independently between 0.35 to 0.75.

10. The container of claim 1, wherein each grip is located at one of two laterally horizontal sides of the container to enable the user to rotate the container about the laterally horizontal axis A₂.

11. The container of claim 10, wherein one of the grips includes tabs each sized and shaped for a lateral grasp by a hand of the user, one of the tabs extending outwardly from the base rim and the other tab extending outwardly from the lid rim, wherein the tabs enable the user to open the container by separating the lid from the base.

12. The container of claim 11, wherein the other grip is a hinge connecting the base rim and the lid rim.

13. The container of claim 1, wherein the lid rim and the base rim engage to create a continuous peripheral seal when the container is formed.

14. The container of claim 13, wherein the base sidewall and the lid sidewall each include structural ribs extending in the direction of the vertical axis A₃, wherein the structural ribs and the elliptic shape of the base and lid rims cooperate to enable a single motion closure of the lid and the base when forming the container via a downward force applied to the lid in the direction of the vertical axis A₃.

15. The container of claim 13, wherein the base rim defines a bead that is received by a trough defined by the lid rim, wherein the bead and trough have complementing S-shaped walls that engage by friction and a middle segment of the bead engages a middle segment of the trough to create the continuous peripheral seal when the container is formed.

16. The container of claim 15, wherein:
the bead includes at least one first series of vent channels each extending upwardly along the S-shaped wall of the bead and outwardly along the middle segment of the bead,
the trough includes at least one second series of vent channels extending outwardly from the lid sidewall and downwardly along the S-shaped wall of the trough, and
when the container is formed, each of the vent channels of the at least one first series aligns with one of the vent channels of the at least one second series when the container is formed, and each aligned pair of vent channels is in fluid communication with the lid and base chambers and terminates prior to an outer edge of the peripheral seal to allow heat and steam to vent from the container while limiting leakage of the contents from the container.

17. The container of claim 1, wherein the base sidewall and the lid sidewall include structural ribs extending in the direction of the vertical axis A₃ and outwardly from the respective sidewall, wherein the structural ribs are V-shaped and taper to a reduced surface area at a terminal outer point of the ribs.

18. A method of mixing contents using the container of claim 1, the method comprising:
placing the contents within the base chamber;
forming the container by engaging the lid rim and the base rim to enclose the contents within the base and lid chambers; and
manually mixing the contents by rotating the container about the laterally horizontal axis A₂, wherein during rotation of the container the contents reciprocate between the base and lid chambers and are centered relative to a plane defined by the longitudinally horizontal axis A₁ and the vertical axis A₃ such that the contents are substantially mixed without rotating the container in another direction.

19. The method of claim 18, wherein forming the container comprises positioning the lid relative to the base such that the lid rim is seated on the base rim and engaging the lid rim and the base rim to create a continuous peripheral seal via a single downward force applied to the lid in the direction of the vertical axis A₃.

20. The method of claim 18, wherein manually mixing the contents comprising rotating the container about the laterally horizontal axis A₂ using grips each located at one of two laterally horizontal sides of the container.
